(19) United States
(12) Patent Application Publication
(10) Pub. No.: US 2024/0095727 A1
(43) Pub. Date: Mar. 21, 2024

(54) METHOD FOR IMPLEMENTING VIRTUAL ASSET VALUE IN REAL ASSET, DEVICE USING THE SAME, AND REAL ASSET HAVING VIRTUAL ASSET VALUE IMPLEMENTED THEREIN

(71) Applicant: HWOAIN CHOI, Seoul (KR)

(72) Inventor: HWOAIN CHOI, Seoul (KR)

(21) Appl. No.: 18/471,101

(22) Filed: Sep. 20, 2023

(30) Foreign Application Priority Data
Sep. 21, 2022 (KR) 10-2022-0119104

(51) Int. Cl. G06Q 20/38; G06Q 20/12; G06Q 20/32; G06Q 20/40; H04L 9/08

(52) U.S. Cl. CPC G06Q 20/3829; G06Q 20/123; G06Q 20/3278; G06Q 20/3823; G06Q 20/3825; G06Q 20/401; H04L 9/0819

(57) ABSTRACT

The present invention relates to a method for implementing a virtual asset value in a real asset that is performed by a first device including a first medium, the method comprising: storing a first cryptographic key required to sign a transaction of a virtual asset in the first media; splitting the first cryptographic key into a plurality of parts; and moving one of the plurality of parts from the first medium to a third medium included in a real asset. According to the present invention, a virtual asset value can be implemented in a real asset, and the real asset can be traded with increased value.

### CROSS-REFERENCE TO RELATED APPLICATION

This application claims priority from Korean Patent Application No. 10-2022-0119104 filed on Sep. 21, 2022, in the Korean Intellectual Property Office, and all the benefits accruing therefrom under 35 U.S.C. § 119, the contents of which in its entirety are herein incorporated by reference.

### BACKGROUND

### 1. Technical Field

The present invention relates to a method for implementing a virtual asset value in a real asset, a device for implementing a virtual asset value in a real asset using the same, and a real asset in which the virtual asset value is implemented, and more particularly, to a method for implementing a value of cryptocurrency in a real asset having exchange value as a single object, a device for implementing the same, and a real asset having a value of cryptocurrency implemented therein.

### 2. Description of the Related Art

A digital asset refers to an item or equipment that exists in a binary format and comes with the right to use. Data without the right to use is not considered an asset. Digital assets encompass digital documents, audio or video content such as music or movies, and other related digital data that is currently in circulation or can be stored in digital devices, but the digital assets are not limited to these examples.

In the traditional sense, a digital asset was an abstract term that referred to tangible or virtual collections such as virtual machines, servers, applications, data, and the like, similar to physical assets. However, due to the impact of blockchain and fintech markets, the meaning of digital assets has evolved significantly. Beyond the traditional sense, the terms “digital asset” is used to refer to cryptocurrency in the blockchain and fintech industries.

A cryptocurrency is a digital currency created using cryptographic techniques. Cryptocurrencies are used in the form of encrypted data in a network-connected Internet space. Because cryptocurrencies exist purely in digital data form without physical presence, they are also referred to as virtual money. Cryptocurrencies are often referred to as crypto assets because they are frequently used for secure asset storage rather than primarily as a means of payment.

Most cryptocurrencies store and transmit value using decentralized peer-to-peer (P2P) blockchain technology. Cryptocurrencies, a type of digital currency created using cryptographic techniques called hash, ensure the reliability and stability of transactions through a decentralized ledger system without the need for a central bank to control the money supply (based on the gold standard) and guarantee the value. Cryptocurrencies is a global currency that is not subjected to national restrictions, and can be considered a form of digital gold.

Therefore, due to their decentralized nature, cryptocurrencies exist on the blockchain, and owners of cryptocurrencies can store the cryptographic keys necessary to transact their owned cryptocurrencies in a digital wallet.

Virtual assets without physical presence are distinctly separate from real assets with physical presence, and since the methods of transaction between the two are distinct, cryptocurrencies belonging to virtual assets can only be traded online.

However, when a portion of the value of cryptocurrencies, currently limited to online transactions, is implemented in real assets, offline transactions of cryptocurrencies become possible, and shared value between real assets and virtual assets may lead to a synergy effect that increases the value of both real and virtual assets.

As one example of technology related to the present invention, an apparatus for providing product authentication information using non-fungible token (NFT) disclosed in the Korean registered patent publication utilizes an NFT issuing unit, a purchase signal transmitting unit, and a sale decision signal receiving unit. This related art involves generating an NFT containing product information, sending a purchase signal to a purchaser, and receiving a sale decision signal to sell the product to the purchaser. The configuration and effects of the related art and the present invention are distinct from each other, given that the present invention pertains to a method and device for implementing the value of virtual assets in real assets, and real assets having virtual asset value implemented therein.

### Related Art Document

(Patent Document 0001) Korean Registered Patent No. 10-2397137 (published on May 12, 2022)

### SUMMARY

Aspects of the present disclosure provide real assets allowing for sharing virtual asset values.

Aspects of the present disclosure provide a method for implementing virtual asset value into a real asset and a device using the same.

According to an aspect of the present disclosure, there is provided a method for implementing a virtual asset value in a real asset, which is performed by a device for implementing a virtual asset value in a real asset, the method including: generating a first cryptographic key required to sign a transaction of a virtual asset; splitting the first cryptographic key into a plurality of parts; and moving one of the plurality of parts to an electronic tag attached to a real asset.

In addition, in the method for implementing a virtual asset value in a real asset, the splitting of the first cryptographic key into a plurality of parts may include splitting the first cryptographic key into a first cryptographic key part and a second cryptographic key part; and encrypting the second cryptographic key part.

Further, in the method for implementing a virtual asset value in a real asset, the encrypting of the second cryptographic key part may be configured to encrypt the second cryptographic key part using a second cryptographic key.

Moreover, in the method for implementing a virtual asset value in a real asset, the second cryptographic key may be configured to be stored together with the first cryptographic key in an electronic wallet of a storage medium included in the device.

In addition, in the method for implementing a virtual asset value in a real asset, the moving of one part may include preparing the real asset with an electronic tag attached; tagging the device to the electronic tag; recording the second cryptographic key part on the electronic tag; and deleting the second cryptographic key part stored in the device.

Additionally, in the deleting of the second cryptographic key part stored in the device, the device may automatically delete the second cryptographic key part from the storage medium after a predetermined period of time.

Moreover, the method for implementing a virtual asset value in a real asset may further include restoring the first cryptographic key by combining the first cryptographic key part and the second cryptographic key part through tagging of the device and the electronic tag; and executing a transaction of the virtual asset using the first cryptographic key.

In addition, in the executing of the transaction of the virtual asset using the first cryptographic key, the transaction may be executed when a transfer of the real asset takes place or is scheduled offline and the transaction of the virtual asset may be characterized by being a transaction with a transferee of the real asset as a recipient.

In addition, the method for implementing a virtual asset value in a real asset may further include purchasing a real asset; and receiving the virtual asset associated with the real asset online.

Additionally, in the method for implementing a virtual asset value in a real asset, the electronic tag may be a near field communication (NFC) electronic tag.

Furthermore, in the method for implementing a virtual asset value in a real asset, the electronic tag may be configured to contain authentication information of the real asset.

According to an aspect of the present invention, there is provided a device for implementing a virtual asset value in a real asset, including: a cryptographic key generation unit configured to generate a first cryptographic key required to sign a transaction of a virtual asset; a storage medium configured to store the generated first cryptographic key; a cryptographic key splitting unit configured to split the first cryptographic key into a plurality of parts including at least a first cryptographic key part and a second cryptographic key part; a cryptographic key input/output unit configured to output the second cryptographic key part to an electronic tag attached to a real asset associated with the virtual asset and receive and store the second cryptographic key part stored in the electronic tag; and a cryptographic key restoration unit configured to combine the split fist cryptographic key part and second cryptographic key part with each other.

In addition, the device for implementing a virtual asset value in a real asset may include a real asset that is a product subject to trading or has exchange value; and an electronic tag attached to the real asset, wherein the electronic tag may store a second cryptographic key part split from a first cryptographic key required to sign a transaction of a virtual asset associated with the real asset and the second cryptographic key part may be configured to be used for signing the transaction of the virtual asset through a combination with a first cryptographic key part split from the first cryptographic key.

In addition, the device for implementing a virtual asset value in a real asset may be configured such that the electronic tag stores the second cryptographic key part through NFC tagging.

Moreover, the device for implementing a virtual asset value in a real asset may be characterized in that the real asset includes a metal ring and the metal ring functions as a radio frequency identification (RFID) antenna.

Further, the device for implementing a virtual asset value in a real asset may be characterized in that the real asset is one of jewelry products.

The details of other embodiments are incorporated in “DETAILED DESCRIPTION OF THE EMBODIMENTS” and accompanying “Drawings”.

The advantages and/or features, and schemes of achieving the advantages and features of the present invention will be apparently comprehended by those skilled in the art based on the embodiments, which are detailed later in detail, together with accompanying drawings.

This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The present invention is only defined within the scope of accompanying claims.

### BRIEF DESCRIPTION OF THE DRAWINGS

FIG. 1 is a network relationship diagram of a system for implementing a virtual asset value in a real asset according to an embodiment of the present invention.

FIG. 2 is a block diagram illustrating a device for implementing a virtual asset value in a real asset according to an embodiment of the present invention.

FIG. 3 is a block diagram of a real asset having virtual asset value implemented therein according to an embodiment of the present invention.

FIG. 4 is a diagram illustrating a first device, a second device, and a third device corresponding to a device for implementing a virtual asset value in a real asset according to an embodiment of the present invention.

FIG. 5 is a flowchart illustrating a method for implementing a virtual asset value in a real asset according to an embodiment of the present invention.

FIG. 6 is a flowchart illustrating a method for implementing a virtual asset value in a real asset according to an embodiment of the present invention.

FIG. 7 is a diagram illustrating the splitting into cryptographic key parts according to an embodiment of the present invention.

FIG. 8 is a diagram illustrating cryptographic key part combination according to an embodiment of the present invention.

FIG. 9 is a diagram illustrating a process of transmitting a virtual asset and delivering a real asset associated with the virtual asset according to one embodiment of the present invention.

FIG. 10 is a flowchart illustrating a method for implementing a virtual asset value in a real asset according to an embodiment of the present invention.

### DETAILED DESCRIPTION OF THE EMBODIMENTS

Before describing the present invention in detail, terms and words used herein should not be construed in an ordinary or dictionary sense and should not be construed as limiting the invention to the inventors of the present invention in the best way possible, and it is to be understood that the concepts of various terms can be properly defined and used, and further, these terms and words should be construed as meaning and concept consistent with the technical idea of the present invention.

That is, the terms used herein are used only to describe preferred embodiments of the present invention and are not intended to specifically limit the contents of the present invention, and it should be noted that this is a defined term considering that many possibilities of the present invention.

Also, in this specification, the singular forms “a”, “an”, and “the” include plural referents unless the context clearly dictates otherwise, and similarly it should be understood that even if they are expressed in plural they may include singular meaning.

Where an element is referred to as “comprising” or “including” another element throughout this specification, unless explicitly described to the contrary, this will be understood to imply the inclusion of stated elements but not the exclusion of any other elements.

Further, when it is stated that an element is “inside or connected to another element”, this element may be directly connected to another element or may be installed in contact with it, or may be installed spaced apart with a predetermined distance, and in the case where an element is installed to be spaced apart with a predetermined distance, a third element or means for fixing or connecting the element to another element may be present, and it should be noted that the description of the third element or means may be omitted.

In contrast, when an element is described as being “directly connected to” or “directly coupled to” or “directly access” another element, there are no intervening elements present.

Similarly, other words used to describe the relationship between elements should be interpreted in a like fashion (e.g., “between” versus “directly between”, “adjacent” versus “directly adjacent”, etc.).

In the following description, the terms of “one surface”, “opposite surface”, “one side”, “opposite side”, “first”, and “second”, if used, are used to clearly distinguish between one component and a different component, and the meanings of relevant components should not be limited by these terms.

Further, in the following description, terms of “on”, “under”, “left”, and “right” related to a position, if used, should be interpreted as representing a relative position of a relevant component in a relevant drawing. In addition, unless the position is not specified as an absolute position, the terms related to the position should not be interpreted as representing the absolute position.

In addition, regarding the reference numerals assigned to the elements in the drawings, it should be noted that the same elements will be designated by the same reference numerals, wherever possible, even though they are shown in different drawings. In other words, throughout the specification, the same reference numeral is assigned to the same element.

It is to be understood that the size, position, coupling relationships and such, of each component constituting the present invention in the accompanying drawings, may be partially exaggerated or reduced or omitted to be able to sufficiently clearly convey the scope of the invention or for convenience of describing, and therefore the proportion or scale thereof may not be rigorous.

Also, in the following description of the present invention, a detailed description of a configuration that is considered to unnecessarily obscure the gist of the present invention, for example, a known technology including the prior art, may be omitted.

Hereinafter, an exemplary embodiment of the present invention will be described in detail with reference to accompanying drawings.

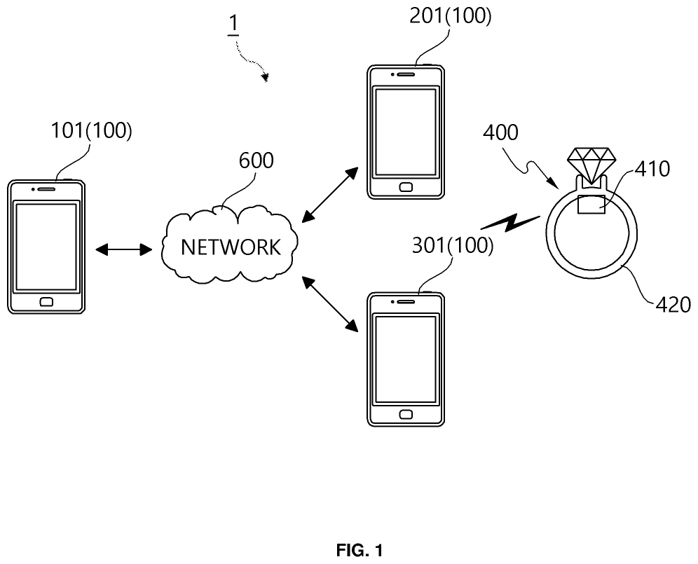

FIG. 1 is a network relationship diagram of a system for implementing a virtual asset value in a real asset according to an embodiment of the present invention.

Referring to FIG. 1, a system 1 for implementing a virtual asset value in a real asset according to an embodiment of the present invention includes a first device 101, a second device 201, a third device 301, a real asset 400 which is capable of short-range communication with these devices and in which virtual asset value is implemented, and a network 600 connecting them for communication.

Since the first device 101 through the third device 301 are illustrative, additional devices, a fourth device 401 to an Nth device N01 may be further included in the system 1 for implementing a virtual asset value in a real asset.

For convenience of explanation, the relationship among the first device 101 of a seller who sells a real asset 420, which is a product, the second device 201 of a purchaser who purchases the real asset 420 with an electronic tag 410 attached (hereinafter simply referred to as a “real asset 420”) from the seller, and the third device 301 of a recipient who receives the real asset 420 as a gift from the purchaser is described hereinafter. The first device 101, the second device 201, and the third device 301 correspond to devices 100 for implementing a virtual asset value in a real asset.

A virtual asset according to an embodiment of the present invention, contrary to the real asset 420, refers to a digital asset such as cryptocurrency and non-fungible token (NFT). For the sake of explanation, cryptocurrencies and NFTs are used as examples of virtual assets.

The device 100 for implementing a virtual asset value in a real asset has the capability to implement virtual asset value in real assets. Here, an electronic tags 410 may be attached to the real asset 420. The electronic tag 410 may record virtual asset value.

Virtual asset value is a distinct concept from virtual assets and refers to a cryptographic key used for ownership of virtual assets. The scope of virtual assets encompasses various cryptocurrencies and various types of digital assets, for example, fungible token (FT), semi-fungible token (SFT), NFT, and combinations thereof, such as a combination of FT and NFT. A first cryptographic key 170 used to execute transactions of a cryptocurrency, which is one example of virtual assets, is described as an example of virtual asset value. The first cryptographic key 170 may be split into at least a first part 171 (hereinafter referred to as a “first cryptographic key part 171”) and a second part 172 (hereinafter referred to as a “second cryptographic key part 172”), and a second cryptographic key 180 may be used for encryption of the second cryptographic key part 172. Detailed description of the entirety of the cryptographic key will be provided below.

Hereinafter, a detailed description of the device 100 for implementing a virtual asset value in a real asset according to one embodiment of the present invention will be provided.

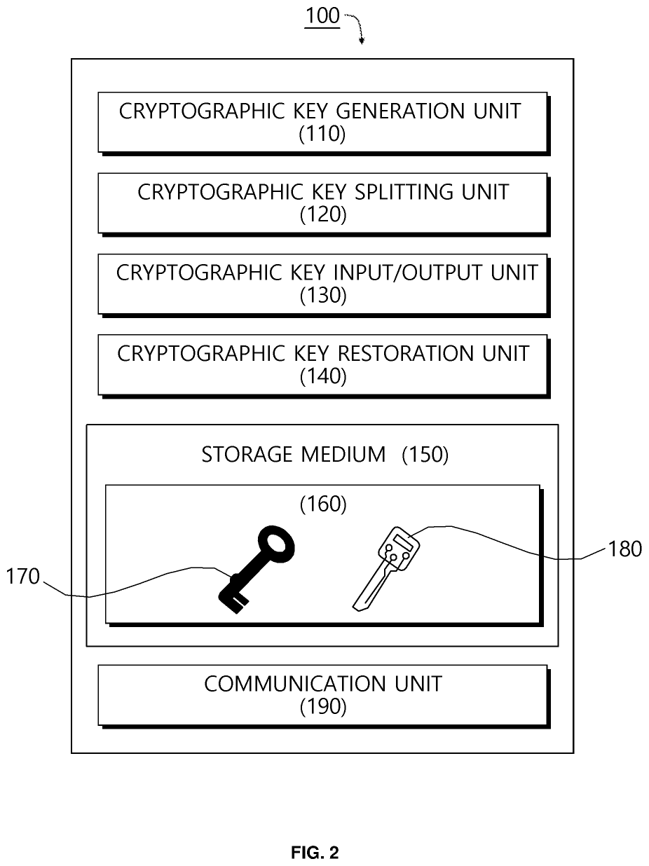

FIG. 2 is a block diagram illustrating a device for implementing a virtual asset value in a real asset according to an embodiment of the present invention.

Referring to FIG. 2, the device 100 for implementing a virtual asset value in a real asset may be configured to include a cryptographic key generation unit 110, a cryptographic key splitting unit 120, a cryptographic key input/output (I/O) unit 130, a cryptographic key restoration unit 140, a storage medium 150, and a communication unit 190. The storage medium 150 may store an electronic wallet 160, and the electronic wallet 160 may contain the first cryptographic key 170 and the second cryptographic key 180.

The device 100 for implementing a virtual asset value in a real asset corresponding to the first device 101, the second device 201, and the third device 301 may be implemented in the form of a mobile terminal such as a smartphone, a tablet computer, a laptop, or a desktop such as a personal computer (PC), with relevant programs installed that perform the method for implementing a virtual asset value in a real asset.

The cryptographic key generation unit 110 has the function of generating the first cryptographic key 170 for a cryptocurrency. The system 1 for implementing a virtual asset value in a real asset may be configured such that the cryptographic key generation unit 110 of the first device 101 or the second device 201 generates the first cryptographic key 170. Assuming that the user of the first device 101 is a seller and the user of the second device 201 is a purchaser, the first cryptographic key 170 that can be used to sign cryptocurrency transactions may be generated by the first device 101 of the seller who sells the real asset 420, or the second device 201 of the buyer 20. For the convenience of description, it is assumed that the second device 201 of the purchaser generates the first cryptographic key 170 according to one embodiment of the present invention.

The cryptographic key splitting unit 120 has the function of splitting the first cryptographic key 170 into a plurality of parts, including at least the first cryptographic key part 171 and the second cryptographic key part 172. In other words, the first cryptographic key 170 may also be split into additional parts, such as a third cryptographic key part to an Nth cryptographic key part, besides the first cryptographic key part 171 and the second cryptographic key part 172. The system 1 for implementing a virtual asset value in a real asset may be configured such that the cryptographic key splitting unit 120 of the first device 101 or the second device 201 splits the first cryptographic key 170.

The first cryptographic key 170 may be split using a splitting algorithm. Each part of the first cryptographic key 170 split using the splitting algorithm may be recombined using the splitting algorithm in reverse.

According to one embodiment of the present invention, various methods of splitting algorithms may be employed. For example, the first cryptographic key 170 with a value of 0'1234 may be split into the first cryptographic key part 171 with a value of 0×1230 and the second cryptographic key part 172 with a value of 0×0004, on a bit-by-bit basis. The second cryptographic key part 172 with a value of 0×0004 may then be encrypted using the second cryptographic key 180.

Unlike traditional cryptographic operations where encryption ensures the security and integrity of communication or storage and attackers may be external to the systems of participants, i.e., senders and receivers, encryption in a multiparty computation model protects participants' private information from each other.

The cryptographic key I/O unit 130 has a function of outputting the second cryptographic key part 172 stored in the storage medium 150 to the electronic tag 410 and receiving the second cryptographic key part 172 stored in the electronic tag 410 as input. Here, “output” refers to the read and write function of the second cryptographic key part 172 to the electronic tag 410, and “input function” refers to the read function of the second cryptographic key part 172 from the storage medium 150.

The cryptographic key I/O unit 130 may perform input and output functions through the communication unit 190. Further details of the communication unit 190 will be provided below.

Output to the electronic tag 410 and input to the storage medium 150 may be performed by a single device or by different devices. For example, the second device 201 may output the second cryptographic key part 172 to the electronic tag 410 and then input the same second cryptographic key part 172, stored in the electronic tag 410, to the storage medium 150. Alternatively, the second device 201 may output the second cryptographic key part 172 to the electronic tag 410, and the third device 301 may then input the same second cryptographic key part 172, stored in the electronic tag 410, to the storage medium 150 within the third device 301. In this case, the real asset 420 containing the electronic tag 410 is required to be transferred from the user of the second device 201, the purchaser, to the user of the third device 301, the recipient.

Through the output of the cryptographic key I/O unit 130 of the first device 101 or the second device 201, the second cryptographic key part 172 may be recorded on the electronic tag 410. When the second device 201 outputs the second cryptographic key part 172 to the electronic tag 410, the original of the second cryptographic key part 172 remains on the storage medium 150 of the second device 201, while a copy of second cryptographic key part 172 exists on the electronic tag 410. Since only one instance of the second cryptographic key part 172 should exist, the second cryptographic key part 172 on the storage medium 150 of the first device 101 should be deleted. Therefore, the second device 201 may be configured to delete the second cryptographic key part 172 from the storage medium 150 after a predetermined period of time. Alternatively, the second cryptographic key part 172 may be directly moved to the electronic tag 410 using a move function.

When the real asset 420 with the electronic tag 410 attached containing the recorded second cryptographic key part 172 is transferred from the user of the second device 201, the purchaser, to the recipient, the cryptographic key I/O unit 130 within the third device 301 of the recipient may receive the second cryptographic key part 172 from the electronic tag 410 and store it in the storage medium 150 within the third device 301. As a result, the second cryptographic key part 172, corresponding to the virtual asset value, may be passed from one user to another, i.e., from the purchaser to the recipient, through the medium of the real asset 420.

The cryptographic key restoration unit 140 has a function of combining the split first cryptographic key part 171 and second cryptographic key part 172. For example, the cryptographic key restoration unit 140 of the second device 201 may recombine the first cryptographic key part 171 and the second cryptographic key part 172 received again from the electronic tag 410. In this case, the decryption of the second cryptographic key part 172 may occur before the combination.

At least one of the first cryptographic key part 171 or the second cryptographic key part 172, for example, the second cryptographic key part 172, may contain splitting information. Moreover, the second cryptographic key part 172 may be encrypted using the second cryptographic key 180. For example, the key splitting unit 120 may encrypt second cryptographic key part 172 along with its splitting information using the second cryptographic key 180. In addition, the second cryptographic key 180 may be recorded on the electronic tag 410 along with the encrypted second cryptographic key part 172. Also, the real asset 420 with the electronic tag 410 attached may be delivered from the purchaser to the recipient. The delivery method may involve direct transfer or a transportation system.

The storage medium 150 has a function of storing the generated first cryptographic key 170. Specifically, the storage medium 150 may can include an electronic wallet 160, which may store the first cryptographic key 170 and the second cryptographic key 180.

The storage medium 150 may be implemented as an external or internal device of the device 100 for implementing a virtual asset value in a real asset. When implemented as an external device, a USB memory may be used as the storage medium 150, and when implemented as an internal device, flash memory may be used as the storage medium 150.

For example, the first cryptographic key 170 may be a type of private key, denoted as K. The cryptographic key generation unit 110 may generate the first cryptographic key 172, K. The cryptographic key splitting unit 120 may split a private key as K=Ka (first cryptographic key part)+Kb (second cryptographic key part)=0×1234=0×1230+0×0004, for example. The cryptographic key splitting unit 120 may encrypt the second cryptographic key part 172, Kb, as follows: Kb′=Encrypt(Kb, α)=Encrypt(0×0004, 0×abcd), where α is the second cryptographic key 180, which is a type of symmetric key. Kb′ corresponding to the second cryptographic key part 172 is recorded on the electronic tag 410.

The cryptographic key restoration unit 140 may decrypt the encrypted second cryptographic key part 172 as Kb=Decrypt(Kb′, α)=(0×7b4d, 0×abcd)=0×0004. Next, the cryptographic key restoration unit 140 restores the first cryptographic key 170, K as K=Ka+Kb=0×1230+0×0004.

The configuration of the cryptographic key generation unit 110, the cryptographic key splitting unit 120, the cryptographic key I/O unit 130, the cryptographic key restoration unit 140, and the storage medium 150 mentioned so far may be equally applied to the first device 101, the second device 201, and the third device 301.

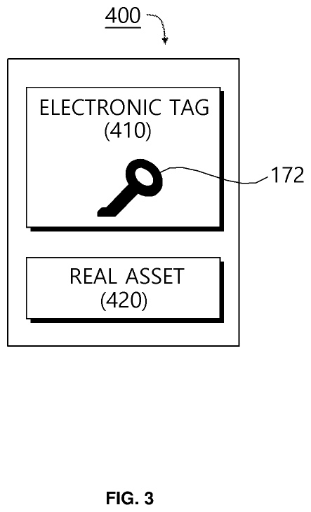

FIG. 3 is a block diagram of a real asset having virtual asset value implemented therein according to an embodiment of the present invention.

Referring to FIG. 3, the real asset 400 having virtual asset value implemented therein according to an embodiment of the present invention may be configured to include a real asset 420 that is a product subject to trading or has exchange value and an electronic tag 410 attached to the real asset 420. The electronic tag 410 can store a second cryptographic key part 172 separated from a first cryptographic key 170.

The real asset 420 may be one of jewelry products. Therefore, within the scope of real asset 420, various types of jewelry such as rings, necklaces, bracelets, anklets, headbands, tiaras, and brooches may be included, provided they can be coupled with the electronic tag 410. A ring is given as an example of real asset 420 below.

The device 100 for implementing a virtual asset value in a real asset may split a cryptographic key into a plurality of cryptographic key parts. For example, a first cryptographic key 170 may be split into a first cryptographic key part 171 and a second cryptographic key part 172. The device 100 has a function of implementing the second cryptographic key part 172 (the first cryptographic key part is also possible), among the split cryptographic key parts, in the ring that corresponds to the real asset 420, specifically recording it on the electronic tag 410 attached to the real asset 420. Additionally, the device 100 for implementing a virtual asset value in a real asset also has a function of combining the split first cryptographic key part 171 and second cryptographic key part 172.

Through tagging between the electronic tag 410 and the device 100 for implementing a virtual asset value in a real asset, the split second cryptographic key part 172 may be stored in and deleted from the electronic tag 410. Therefore, the second cryptographic key part 172 stored in the electronic tag 410 may be used for signing virtual asset transactions through its combination with the remaining first cryptographic key part 171.

In the case where the real asset 420 is a ring, the ring includes a metal ring 421, which is characterized by functioning as a short-range communication antenna, such as a radio frequency identification (RFID) antenna.

The real asset 420 may be delivered from the seller to the purchaser in a state where the electronic tag 410 is combined, through a transaction between the seller and the purchaser. In addition, if there is a virtual asset that is sold in association with the real asset 420, the associated virtual asset may also be transmitted from the device 101 of the seller to the device 201 of the purchaser. Here, the concept of transferring blockchain-based virtual assets does not imply the direct movement of virtual assets, but rather the recording of the sender, recipient, and transferred amount in a transaction ledger stored on the blockchain.

The second device 201 may pre-store or subsequently generate the first cryptographic key required for managing the received virtual asset. The first cryptographic key 170 stored in the second device 201 may undergo the splitting process, and the split second cryptographic key part 172 may be moved to the electronic tag 410 attached to the real asset 420 that is a purchased product.

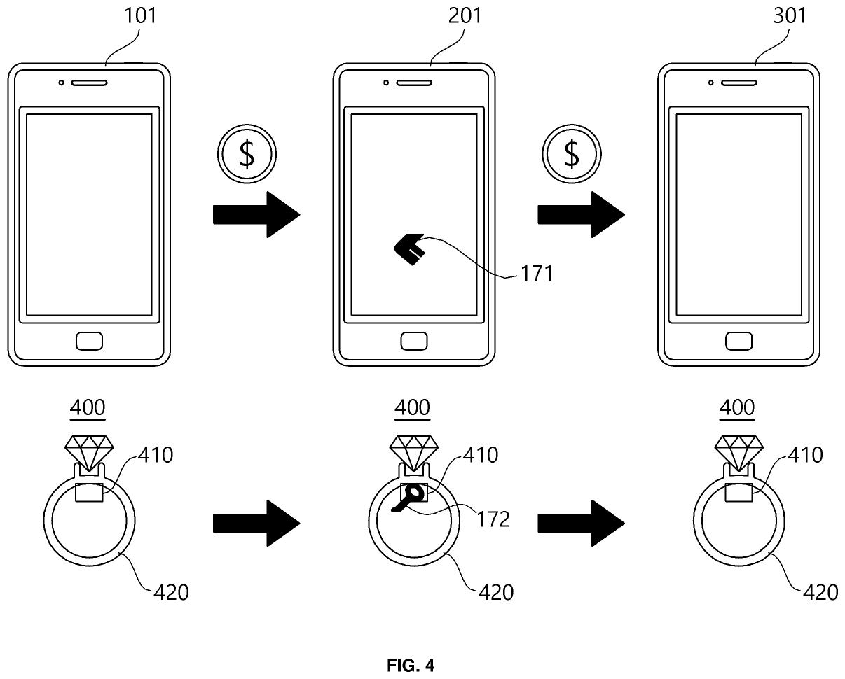

FIG. 4 is a diagram illustrating a first device, a second device, and a third device corresponding to a device for implementing a virtual asset value in a real asset according to an embodiment of the present invention.

Referring to FIG. 4, a first device 101 of a seller of the real asset 420 with an electronic tag 410 attached, a second device 201 of the purchaser, and a third device 301 of a recipient are depicted along with the real asset 420 with the electronic tag 410 attached, that is, the real asset 400 having virtual asset value implemented therein.

The seller may deliver the real asset 420 with the electronic tag 410 attached to the purchaser through a transaction. In cases where a virtual asset is associated with the real asset and is sold together, the first device 101 of the seller may transmit the virtual asset associated with the real asset to the second device 201.

The second device 201 of the purchaser may split the first cryptographic key 170 of the purchaser into a first cryptographic key part 171 and a second cryptographic key part 172, and through tagging, move the second cryptographic key part 172 to the electronic tag 410.

The second device 201 may transmit all or part of the virtual asset, received from the first device 101, to the third device 301. The purchaser, who is the user of the second deice 201, may then deliver the real asset 420 with the electronic tag 410 attached to the recipient. The second device 201 may perform virtual asset transactions before splitting the first cryptographic key 170, or restore the first cryptographic key part and second cryptographic key part split from the first cryptographic key to execute virtual asset transactions.

The third device 301 may receive the virtual asset from the second device 201, and the recipient, who is the user of the third device 301, may receive the real asset 420 from the purchaser. Subsequently, the third device 301 of the recipient may, like the second device 201, split the cryptographic key of the recipient and move a part of it to the electronic tag 410 attached to the real asset 420.

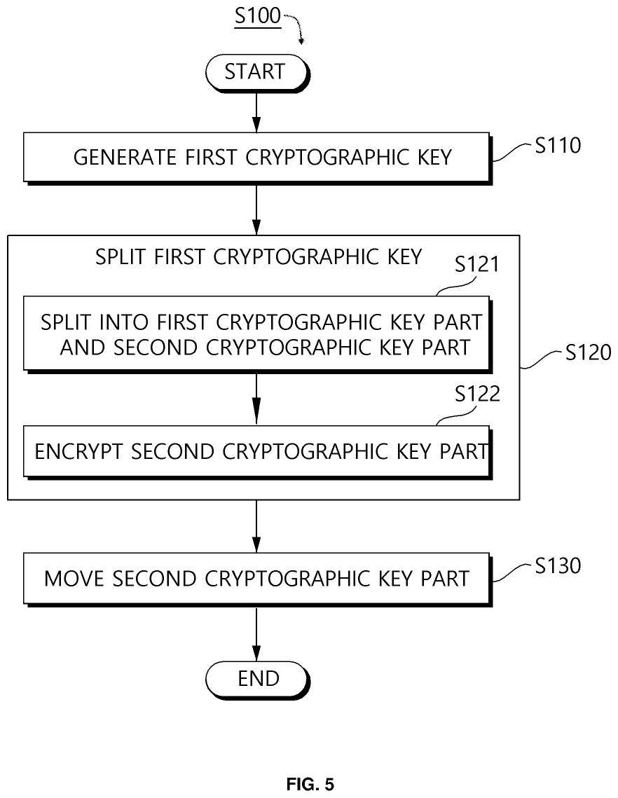

FIG. 5 is a flowchart illustrating a method for implementing a virtual asset value in a real asset according to an embodiment of the present invention.

Referring to FIG. 5, the method (S100) for implementing a virtual asset value in a real asset may include generating a first cryptographic key (S110), splitting the first cryptographic key (S120), and moving a second part of the first cryptographic key 172 (S130).

A second device 201 that corresponds to a device 100 for implementing asset value in real assets may generate and store the first cryptographic key 170 in a storage medium (S110). The second device 201 may generate the first cryptographic key 170 using a mnemonic or other methods without a mnemonic. The first cryptographic key 170 may be stored in an electronic wallet 160 of the storage medium 150.

Then, a cryptographic key splitting unit 120 of the second device 201 may split the first cryptographic key 170 into a plurality of parts, for example, at least a first cryptographic key part 171 and a second cryptographic key part 172 (S120). The cryptographic key splitting unit 120 may employ a splitting algorithm, for example, based on multi-party computation, to split the first cryptographic key 170 into a plurality of parts (S121). Additionally, the cryptographic key splitting unit 120 of the second device 201 may encrypt at least one of the first cryptographic key part 171 or the second cryptographic key part 172, for example, the second cryptographic key part 172, using a second cryptographic key 180 (S122). The second cryptographic key 180 may also be stored in the electronic wallet 160 along with the first cryptographic key 170.

Next, the second device 201 may move the encrypted second cryptographic key part 172 and the second cryptographic key 180 to an electronic tag 410 through the tagging of the real asset 420 with the electronic tag 410 attached (S130).

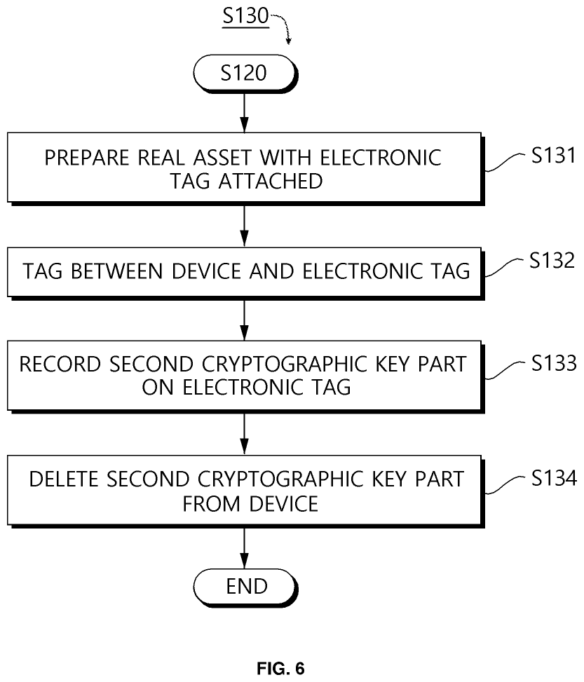

FIG. 6 is a flowchart illustrating a method for implementing a virtual asset value in a real asset according to an embodiment of the present invention.

Referring to FIG. 6, operation S130 depicted in FIG. 5 is divided into detailed operations. Operation 5130 may include preparing a real asset with a storage medium 150 (S131), tagging between the device and the electronic tag 410 (S132), recording the second cryptographic key part 172 on the electronic tag 410 (S133), and deleting the second cryptographic key part 172 from the device (S134).

The process of moving the second cryptographic key part 172 may include recording the encrypted second part 172 on the electronic tag 410 (S133) and deleting the encrypted second cryptographic key part 172 from the storage medium 150 (S134).

The second device 201 and the electronic tag 410 may communicate with each other using RFID communication. Therefore, a communication unit 190 of the device 100 for implementing a virtual asset value in a real asset corresponding to the second device 201 may include a signal generator, a receiver, and a signal detector. Additionally, the electronic tag 410 may have a configuration of an RFID tag used for electromagnetic induction communication.

For example, the second device 201 has a function of reading information stored in the electronic tag 410 through contact or short range contactless tagging of the electronic tag 410, or writing information stored in the storage medium 150 onto the electronic tag 410. Thus, the second device 201 may record the encrypted second cryptographic key part 172 on the electronic tag 410 through the write function. Furthermore, the second device 201 may be configured to delete the second cryptographic key part 172 stored in the storage medium 150 after a predetermined period of time. However, even after the lapse of the predetermined period of time, the second device 201 may decrypt the encrypted second cryptographic key part 172 stored on the electronic tag 410, and restore the first cryptographic key 170 by combining the decrypted second cryptographic key part 172 with the first cryptographic key part 171 stored in the storage medium 150.

When the second cryptographic key part 172 is recorded on the electronic tag 410 attached to the real asset 320 through operation 5130, the virtual asset value is finally implemented in the real asset 420. This is because the second cryptographic key part 172 may be used to sign transactions of the virtual asset.

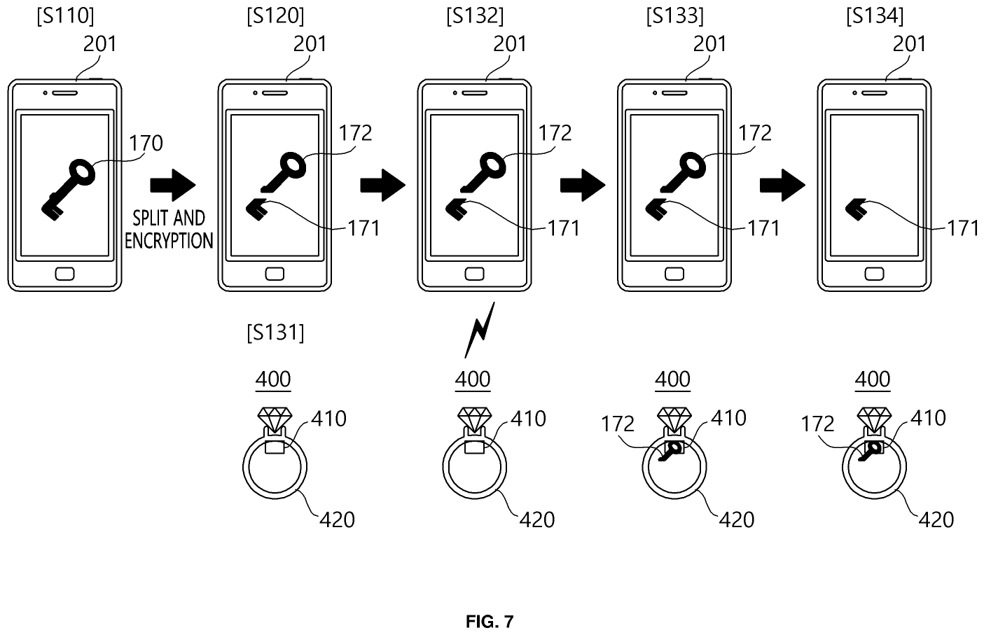

FIG. 7 is a diagram illustrating the splitting into cryptographic key parts according to an embodiment of the present invention.

Referring to FIG. 7, each operation of FIGS. 5 and 6 is depicted.

Operation S110 is a state in which the second device 201 stores the first cryptographic key 170.

Operation S120 is a state in which the second device 201 splits the first cryptographic key 170 into the first cryptographic key part 171 and the second cryptographic key part 172 and stores them. The second cryptographic key part 172 may be encrypted using the second cryptographic key 180.

In S131, the real asset 420 with the electronic tag 410 attached is prepared. The real asset 420 with the electronic tag 410 attached may be delivered from the seller to the purchaser. In this case, a virtual asset associated with the real asset may be transmitted from the first device 101 to the second device 201. The purchaser corresponds to the user of the second device 201. The second device 201 corresponds to the device 100 for implementing a virtual asset value in a real asset according to one embodiment of the present invention.

In S132, the second device 201 is in a state where the electronic tag 410 is tagged. The second device 201 and the electronic tag 410 may be connected through near-field communication (NFC) tagging, and the second device 201 may input and output data through near-field communication, enabling it to read and write information in relation to the electronic tag 410.

In S133, the second device 201 is in a state where the second cryptographic key part 172 is recorded on the electronic tag 410.

In S134, the second device 201 is in a state where the second cryptographic key part 172 has been deleted from the storage medium 150. In other words, the second cryptographic key part 172 is in a state of being moved from the storage medium 150 of the second device 201 to the electronic tag 410.

The split first cryptographic key part 171 and second cryptographic key part 172 may be combined with each other to restore the first cryptographic key 170.

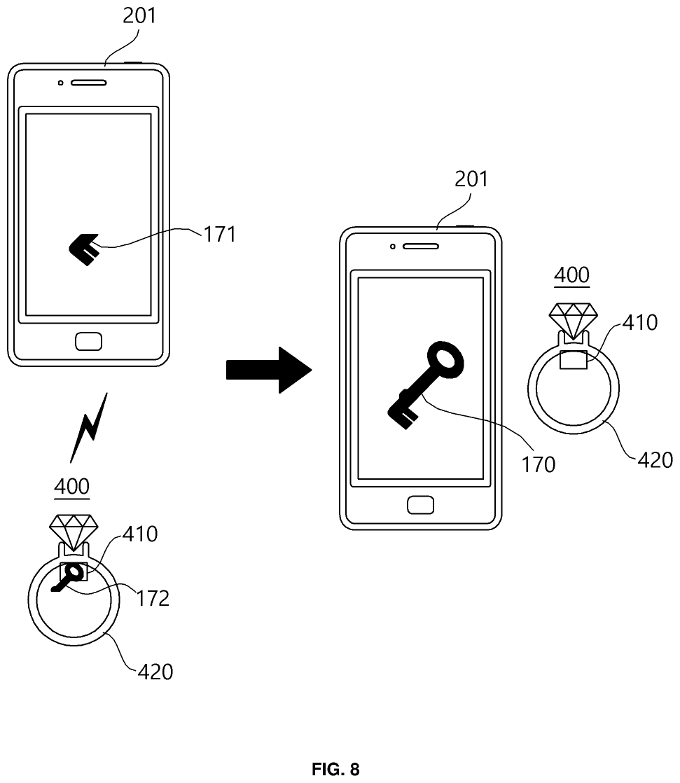

FIG. 8 is a diagram illustrating cryptographic key part combination according to an embodiment of the present invention.

Referring to FIG. 8, a process of restoring the first cryptographic key 170 in the second device 201 through the tagging of the second device 201 and the electronic tag 410 is depicted.

Even after the first cryptographic key 170 is split into the first cryptographic key part 171 and the second cryptographic key part 172, the first cryptographic key 170 may be restored through the tagging of the second device 201 and the electronic tag 410. Because part or all of the virtual asset associated with to the real asset 420, or an additional virtual asset, may be transmitted from the second device 201 to the third device 301, if a portion of the virtual asset associated with the real asset 420 remains under the ownership of the purchaser, the second device 201 may continue to store the restored first cryptographic key 170 and use it to execute transactions involving the remaining virtual asset.

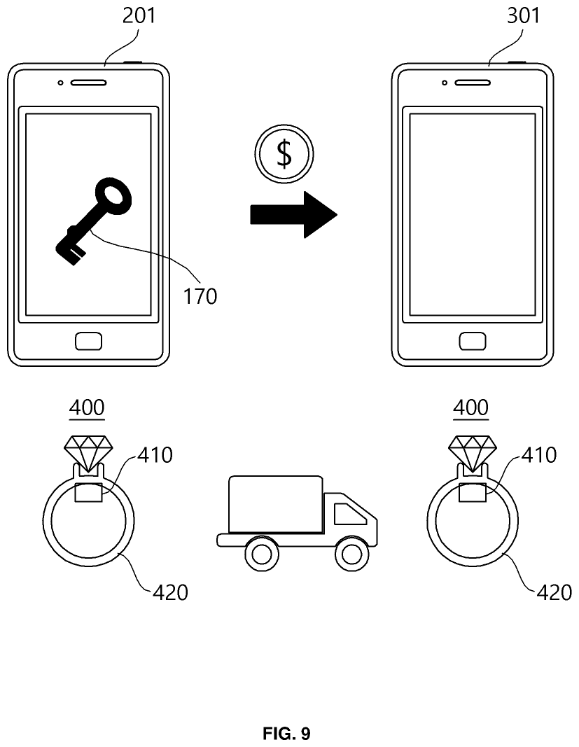

FIG. 9 is a diagram illustrating a process of transmitting a virtual asset and delivering a real asset associated with the virtual asset according to one embodiment of the present invention.

Referring to FIG. 9, for example, a virtual asset may be transferred from the second device 201 to the third device 301, and the real asset 420 with the electronic tag 410 attached may be delivered to the recipient via personal delivery or courier services. During the delivery of the real asset 420 with the electronic tag 410 attached, the transmission of the virtual asset is not necessarily required. There may be no virtual asset associated with the real asset 420, and even if there is associated virtual asset, only a portion of it may be transmitted or none at all. Alternatively, virtual assets exceeding the associated one may also be transmitted.

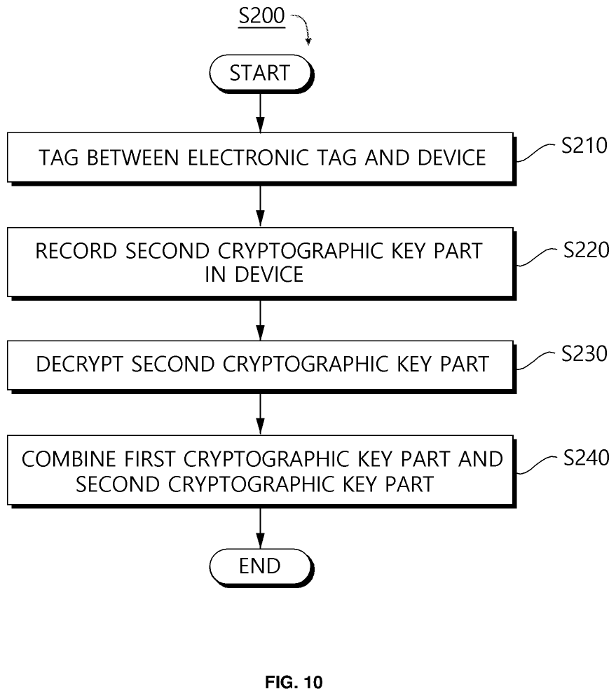

FIG. 10 is a flowchart illustrating a method for implementing a virtual asset value in a real asset according to an embodiment of the present invention.

Referring to FIG. 10, a method S200 for implementing a virtual asset value in a real asset according to an embodiment of the present invention may include tagging between an electronic tag 410 and a third device 301 (S201), recording a second cryptographic key part 172 in the third device 301 (S220), decrypting the second cryptographic key part 172 (S230), and combining the second cryptographic key part 172 with a first cryptographic key part 171 (S240).

As such, according to one embodiment of the present invention, it is possible to implement a virtual asset value in a real asset.

In addition, through transactions of a real asset in which a virtual asset value is implemented, indirect offline transactions of the virtual asset become possible.

Additionally, the value as a product can be enhanced by including the virtual asset value.

Moreover, with a split cryptographic key, online transmission and offline distribution are possible, and online hacking can be prevented.

According to the present invention, it is possible to implement a virtual asset value in a real asset.

In addition, through transactions of a real asset in which a virtual asset value is implemented, indirect offline transactions of the virtual asset become possible. Additionally, the value as a product can be enhanced by including the virtual asset value.

As described above, although several preferred embodiments of the present invention have been described with some examples, the descriptions of various exemplary embodiments described in the “detailed description of the embodiments” item are merely exemplary, and it will be appreciated by those skilled in the art that the present invention can be variously modified and carried out or equivalent executions to the present invention can be performed from the above description.

In addition, since the present invention can be implemented in various other forms, the present invention is not limited by the above description, and the above description is for the purpose of completing the disclosure of the present invention, and the above description is just provided to completely inform those skilled in the art of the scope of the present invention, and it should be known that the present invention is only defined by each of the claims.

What is claimed:

1. A method for implementing a virtual asset value in a real asset that is performed by a device for implementing a virtual asset value in a real asset, the method comprising:
generating a first cryptographic key required to sign a transaction of a virtual asset;
splitting the first cryptographic key into a plurality of parts; and
moving one of the plurality of parts to an electronic tag attached to a real asset.

2. The method of claim 1, wherein the splitting of the first cryptographic key into a plurality of parts comprises:
splitting the first cryptographic key into a first cryptographic key part and a second cryptographic key part; and
encrypting the second cryptographic key part.

3. The method of claim 2, wherein the encrypting of the second cryptographic key part encrypts the second cryptographic key part using a second cryptographic key.

4. The method of claim 3, wherein the second cryptographic key is configured to be stored together with the first cryptographic key in an electronic wallet of a storage medium included in the device.

5. The method of claim 3, wherein the moving of one part comprises:
preparing the real asset with an electronic tag attached;
tagging the device to the electronic tag;
recording the second cryptographic key part on the electronic tag; and
deleting the second cryptographic key part stored in the device.

6. The method of claim 5, wherein in the deleting of the second cryptographic key part stored in the device, the device automatically deletes the second cryptographic key part from the storage medium after a predetermined period of time.

7. The method of claim 3, further comprising:
restoring the first cryptographic key by combining the first cryptographic key part and the second cryptographic key part through tagging of the device and the electronic tag; and
executing a transaction of the virtual asset using the first cryptographic key.

8. The method of claim 7, wherein in the executing of the transaction of the virtual asset using the first cryptographic key, the transaction is executed when a transfer of the real asset takes place or is scheduled offline, and the transaction of the virtual asset is characterized by being a transaction with a transferee of the real asset as a recipient.

9. The method of claim 1, further comprising:
purchasing a real asset; and
receiving the virtual asset associated with the real asset online.

10. The method of claim 1, wherein the electronic tag is a near field communication (NFC) electronic tag.

11. The method of claim 10, wherein the electronic tag is configured to contain authentication information of the real asset.

12. A device for implementing a virtual asset value in a real asset, comprising:
a cryptographic key generation unit configured to generate a first cryptographic key required to sign a transaction of a virtual asset;
a storage medium configured to store the generated first cryptographic key;
a cryptographic key splitting unit configured to split the first cryptographic key into a plurality of parts including at least a first cryptographic key part and a second cryptographic key part;
a cryptographic key input/output unit configured to output the second cryptographic key part to an electronic tag attached to a real asset associated with the virtual asset and receive and store the second cryptographic key part stored in the electronic tag; and
a cryptographic key restoration unit configured to combine the split fist cryptographic key part and second cryptographic key part with each other.

13. A real asset in which a virtual asset value is implemented, the real asset comprising:
a real asset that is a product subject to trading or has exchange value; and
an electronic tag attached to the real asset,
wherein the electronic tag stores a second cryptographic key part split from a first cryptographic key required to sign a transaction of a virtual asset associated with the real asset, and
the second cryptographic key part is configured to be used for signing the transaction of the virtual asset through a combination with a first cryptographic key part split from the first cryptographic key.

14. The real asset of claim 13, wherein the electronic tag is configured to store the second cryptographic key part through near field communication (NFC) tagging.

15. The real asset of claim 13, wherein the real asset comprises a metal ring and the metal ring functions as a radio frequency identification (RFID) antenna.

16. The real asset of claim 13, wherein the real asset is one of jewelry products.

17. The real asset of claim 13, wherein a second cryptographic key is used for encryption of the second cryptographic key part.

18. The real asset of claim 13, wherein the first cryptographic key is split using a splitting algorithm.

19. The real asset of claim 18, wherein each part of the first cryptographic key split using the splitting algorithm may be recombined using the splitting algorithm.

20. The real asset of claim 13, further comprising a cryptographic key I/O unit configured to output the second cryptographic key part stored in a storage medium to the electronic tag.
